(19) United States
(12) Patent Application Publication
(10) Pub. No.: US 2007/0228097 A1
(43) Pub. Date: Oct. 4, 2007

(54) Organizer and tote bag for use in an airplane

(76) Inventor: Maurice-Andre Recanati, New York, NY (US)

Correspondence Address: Maurice-Andre Recanati, 315 West 70th Street, #16K, New York, NY, 10023, US

(21) Appl. No.: 11/396,757

(22) Filed: Apr. 3, 2006

(51) Int. Cl. A45C 3/00; A45C 13/30; B60R 7/00; A45C 15/00

(52) U.S. Cl. 224/580; 224/585; 224/275; 190/110; 190/115

(57) ABSTRACT

A convertible tote-style pilot bag and inflight organizer for use with an aircraft seat. The bag includes a rigid case, which accommodates adjustable dividers, and an organizer which includes a mobile member hinged at the base by an internal mechanism which prevents overextention without needing restraining straps. Removable pockets within the lighted organizer allow for a user-customizable layout. These pockets hold aviation related items securely using flaps, zippers and elasticized mesh when the organizer is closed for storage and transportation but allow direct access to these items while inflight, optimizing cockpit organization. Modules containing a headset, laptop computer and a combination beverage and transceiver holder are attached using a tab and slot mechanism. Straps permit transportation as a tote or as a backpack and allow the bag to be secured to the aircraft seat while inflight. Integrated casters allow the bag to be rolled.

### REFERENCE CITED

U.S. Patent Documents

| | | | |
|---|---|---|---|
| 4,418,806 | December 1983 | Johnson | 190/111 |
| 4,966,260 | October 1990 | Young | 190/111 |
| 5,234,143 | August 1993 | Mahvi et al. | 224/31 |
| 5,405,068 | April 1995 | Lovett | 224/153 |
| 5,630,537 | May 1997 | Sciacca | 224/629 |
| 5,678,666 | October 1997 | Shyr et al. | 190/102 |
| 5,918,711 | July 1999 | Godshaw | 190/107 |
| 6,085,902 | July 2000 | Fang | 206/373 |
| 6,223,870 | May 2001 | Godshaw | 190/107 |
| 6,431,724 | August 2002 | Tedham et al. | 362/154 |
| 6,502,951 | January 2003 | Marshall | 362/156 |
| 6,533,152 | March 2003 | Dischler | 224/413 |
| 6,763,986 | July 2004 | Santos et al. | 224/585 |
| 6,966,439 | November 2005 | Weleczki | 206/315 |

### BACKGROUND OF THE INVENTION

1. Field of the Invention

The present invention relates generally to bags used by pilots for storage and transport of flight gear. More particularly, the present invention demonstrates a combination tote-style flight bag/in cockpit flight organizer which may be converted between a folded and carrying condition and an unfolded condition in which the bag is secured in accessible and arrayed fashion upon a seat front and a seat back. The tote bag/flight organizer of the present invention possesses a number of individual item carrying compartments particularly suited for holding aviation related items. The present invention may be carried, in the folded condition, by hand, over the shoulder as a tote bag or on both shoulders as a backpack. It may also be rolled on its wheels through the use of a retractable handle.

2. Description of the Prior Art

Previously, flight bags have consisted of large single compartment attache case bags which provided a single top opening to the interior or soft duffel-type bags which provided a couple of large zippered compartments. These bags served to transport aviation related items, such as maps, directories, electronic equipment, fuel testers and headsets to the airplane but lacked the ability to organize items within their vast compartment(s). A drawback of the prior art pilot bags is that the interior storage compartments of the bag are not well adapted for the receipt and organization of bulky equipment, small electronic items, paper charts and other articles which need to be routinely used while in-flight. Articles have a tendency to intermingle proximate the bottom of the bag making their retrieval frustrating, time consuming, difficult and unsafe. Pilots typically have to spend considerable pre-flight time searching for items, removing these items from the bag and setting up the cockpit properly to ensure a safe flight. If a pilot flying alone needed an item which was forgotten in the flight bag, attention was diverted away from the safe operation of the aircraft while the pilot fumbled for the item contained in the bags of the prior art. This safety issue is especially compounded by the fact that most bags of the prior art are designed too large to be conveniently placed in the seat adjacent to the pilot without interfering with the travel of the flight controls; forcing pilots to place their bags directly in back of the pilot's seat.

A car seat organizer can be used to organize the cockpit and receive items transferred from the flight bag before a flight. However the prior art organizers are poorly adapted to aviation related items, were not designed to hold items through air turbulence and lack the ability to close so that items may be securely transported to and from an aircraft or stored for extended periods of time.

Prior art flight bags are typically designed for a unique purpose and lack the ability to customize the bag based on the pilot's desire to carry various optional items, such as a laptop computer, an extra headset, an emergency transceiver or a bottle of water. Because prior art bags are not mission adaptable (a pilot on a long cross country or on an instrument flight typically requires a somewhat different setup, certain pilots seek to carry laptop computers) it is often the case that pilots must carry multiple additional pieces of luggage.

Typically, the prior art tote bags are provided with a shoulder strap for carrying the bag and a center handle for carrying the bag by hand. While functional, this type of strap is poorly suited for carrying the weight of a fully loaded flight bag over long distances.

Other examples of prior art, outside of the field of aviation, are illustrated in U.S. Pat. Nos. 5,918,711 and 6,223,870 issued to Godshaw disclose a collapsible hanging bag. This type of design lacks the ability to adapt to an aircraft seat and requires a hook to remain open.

U.S. Pat. No. 5,630,537 issued to Sciacca discloses a compartmentalized box containing a plurality of drawers. U.S. Pat. No. 6,763,986 issued to Santos discloses a tote bag for use in a vehicle and particularly suited for holding personal and infant/toddler related items. This type of design is inadequate for the storage, transport and in-flight use as an organizer of aviation related material. The design lacks a flight case capable of receiving and organizing flight information binders and electronic equipment, and being constructed of soft and flexible materials cannot protect delicate instruments adequately. The design lacks the ability to carry heavy loads as it is made of non-rigid materials and the weight of its contents is borne only by the cloth at the lowest point.

This prior art is also inadequate for use in an airplane which frequently can bank or pitch at high angles or fly through turbulence as the horizontal member is not fastened to the horizontal portion of the seat and it lacks a mechanism restricting the maximum angle at which it can be opened. Additionally, this prior art does not permit users to rearrange the order and type of enclosure pockets in order to customize the organizer's layout. This prior art also lacks the ability to be easily converted to a backpack so as to permit easier transport and has no provision for detachable attachments such as for the transport of headsets, a laptop computer and a water bottle and emergency transceiver.

To date, no existing bags offer the protection of a rigid flight case with a flight organizer capable of holding and presenting aviation related items during flight and having the ability to close as a tote bag so that items may be transported. Prior art bags do not integrate the ability to customize the bag for the type of flying a pilot plans to do and no aviation bags in the prior art offers the ability to carry its weight on both shoulders or the ability to roll the bag on integrated wheels.

Prior art lighted bags, such as that disclosed in U.S. Pat. No. 6,502,951, issued to Marshall, is their unsuitability for night flying. The lighting system described in the prior art generates a diffuse light, instead of a very narrow beam, its intensity cannot be controlled and it does not provide a means for the selection of red lighting. A narrow beam of red light at very low intensity is recommended by the FAA in order to preserve a pilot's night vision. Unlike Marshall, our lighting system is mounted in a non-removable way into the rigid structure of the bag in order to preserve the aim point of the tightly focused beam in a more precise fashion. This feature also prevents migration of the lighting system in heavy turbulence or if the aircraft is placed in unusual attitudes.

### SUMMARY OF THE INVENTION

The present invention provides an elegant solution to the aforementioned problems experienced in the use of flight bags and car seat organizers. More particularly, the novel apparatus of the present invention can be conveniently used as a tote bag to transport and store aviation related items while allowing these items to be organized in individual pockets and compartments customized for aircraft articles. In the unfolded condition, the present invention is designed to fit securely on the typically narrow seat of a general aviation aircraft without interfering with visibility or the free travel of the flight controls. Unlike foldable compartments described in the prior art, which relied on external straps to prevent a member from overextending, the present invention utilizes an internal rigid hinge-type mechanism to prevent the organizer from opening at an angle greater than about 87 degrees. This prevents the content of the mobile member of the organizer from falling out during strong turbulence or unusual aircraft attitudes while allowing the pilot greater access to items placed in the pockets.

The organizer can be loaded in the order in which the items will be used in flight, hold these items securely during all phases of flight and allow the pilot convenient and direct access to any and all items at all times. This feature considerably shortens the time a pilot needs to setup for a flight and eliminates the distraction caused by in-flight fumbling for items “lost” in prior art bags. In addition, to accommodate pilot preferences the pockets within the organizer may be removed and reattached in a different order, allowing pilots to user-customize the organizer to fit their particular needs. For instance, a pilot might choose to move the larger pocket containing maps in order to accommodate an extra pocket for reading glasses. The present invention clearly reflects the FAA guidelines regarding the optimization of cockpit resource management and organization, and meaningfully increases aircraft safety, especially when single pilot operations are conducted under instrument meterological conditions.

The apparatus of one form of the present invention comprises removable modules which are secured to the flight case through a slot and tab mechanism and secured via a bolt. An aviation headset holder, a laptop computer and a beverage/ emergency transceiver module can be removed in such fashion. The interior of the flight case portion is also fully organizable through the placement of padded dividers which are held in place by velcro tabs. This permits the pilot to keep aviation binders organized and separate from other personal items, such as a change of clothes which may be carried during an overnight trip or electronic equipment such as a global positioning system.

A lighting system, comprising of an optical fiber, is integrated into the pilot bag's compartments in order to facilitate finding pilot supplies during pre-flight, post-flight and in-flight operations, thus greatly increasing safety in low lighting conditions such as night. The use of this lighting system, which generates a red light, allows the brightness and aim-point of the light to be tightly controlled, preventing the loss of the pilot's night vision adaptation.

The strap system can also be adjusted to allow the present invention to be carried on one shoulder, as a tote bag, or, unlike the prior art, to distribute the heavy weight of a fully loaded bag on both shoulders as a backpack. Additionally, unlike the prior art, this pilot bag is also fitted with wheels and a retractable handle permitting a pilot to roll a heavy bag.

### BRIEF DESCRIPTION OF THE DRAWINGS

Reference will now be made to the attached drawings

FIG. 1 is a perspective view of a preferred construction of the organizer tote bag for use in an airplane in accordance with the present invention. The adjustable shoulder strap as well as the handle are represented in this view.

FIG. 2 represents a top-view of the pilot bag of FIG. 1 showing a mesh flashlight holder and the adjustable padded dividers within the flight case; the removable laptop, headset and beverage/transceiver holding modules applied to the flight case; and the organizer shown in the closed configuration.

FIG. 3 is an exploded view of the pilot bag of FIG. 1, drawn in perspective, and reveals the organizer in the open configuration, illustrates the ability to remove and reconfigure the layout of the enclosure defining pockets within the organizer and shows the bag's lighting system. The mechanism which secures the removable headset and beverage/transceiver modules are illustrated and an adjustable padded divider within the flight case is shown.

FIG. 4 is an exploded view of the back of the bag of FIG. 1, drawn in perspective, revealing the shoulder strap system, the integrated wheels and the retractable handle. The mechanism which secures the headset, beverage/transceiver and laptop modules are illustrated and an adjustable padded divider within the flight case is shown.

FIG. 5 is a side view of the pilot bag of FIG. 1, showing the organizer in the open configuration and with the laptop module attached.

FIG. 6 depicts the hinge-type mechanism linking the organizer to the rigid flight case and limiting the mobile member from over-extending.

FIG. 7 is a cross-section of the area shown on FIG. 2 and represents the slot and tab and bolt mechanism which secures the removable modules of FIGS. 3 and 4 to the pilot bag of FIG. 1

FIG. 8 is a cross-section of the area shown on FIG. 2 and represents a cross-sectional view of an adjustable padded divider with its retaining velcro tab.

FIG. 9 is a cross-section of the area shown in FIG. 8 and represents a cross-section through the retaining velcro tab of the adjustable padded divider at the point of attachment to the inside of the flight case.

FIG. 10 is a cross-section of the area shown in FIG. 1 and depicts the hinge-type mechanism in the closed configuration

FIG. 11 is a cross section of the area shown in FIG. 3 and illustrates the hinge-type mechanism at the maximally open configuration of 87 degrees.

FIG. 12 portrays the organizer tote bag for use in an airplane, illustrated in FIG. 1, according to a first preferred application of the present invention. The figure depicts the pilot bag in the open configuration while placed on an aircraft seat and illustrates the preferred strapping system.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DETAILED DESCRIPTION OF THE PREFERRED EMBODIMENT

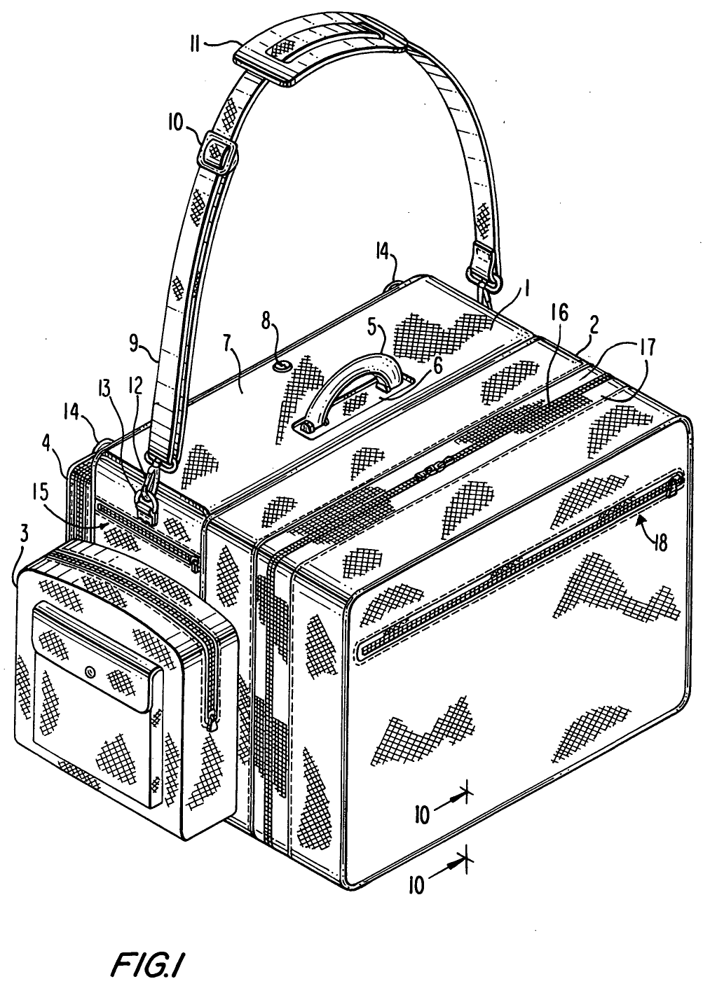

Turning to FIG. 1, the organizer and tote bag for use in an airplane is illustrated according to a first preferred embodiment of the present invention. It consists of a rigid flight case 1, measuring approximately 15 inches in length, 12 inches in height and 6 inches in thickness; an organizer 2 which is shown in the folded (closed) condition and removable modules 3 and 4 for holding such items as an aviation headset and a laptop computer respectively.

The present invention may be carried by a handle 5 which protrudes through a fenestration 6 in the top flap 7 forming the top of the flight case. A lock 8 serves to secure the contents of the case and prevents the two top flaps from opening while the bag is being carried. Alternatively, a shoulder strap 9 consisting of an adjustable buckle 10, a shoulder pad 11 and removable clips 12 may be used to carry the bag. This adjustable shoulder strap is fitted to the flight case 1 through the side mounted D-rings 13. The back mounted D-rings 14 are used in conjunction with the shoulder straps, in order to carry the bag as a backpack, and also to secure the bag to the back of the aircraft seat for in flight use. Zippered compartments on the side of the rigid flight case 15 are insulated in order to facilitate the carriage of in-flight snacks or sandwiches.

The organizer 2 is closed through the use of a zipper 16 mounted on a stretchable skirt 17 in order to allow the organizer to accommodate bulky objects. A zippered compartment on the outside of the organizer 18 allows for the storage of miscellaneous items.

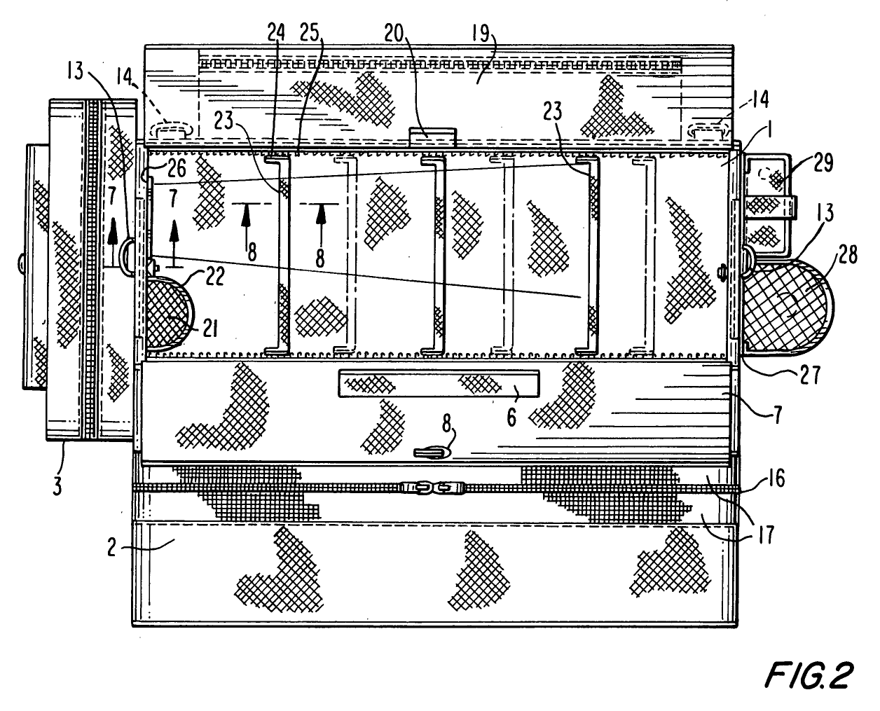

Referring now to FIG. 2, which illustrates a top view of the flight bag and the contents of the rigid flight case 1. The top flaps 7 and 19, drawn in the open position, reveal the closure mechanism 8 and 20 comprising of a keylock-tab and a notch respectively. Inside the case, a mesh pocket 21 with an elasticized rim 22 can be used to securely hold a flashlight or a handheld GPS unit. Adjustable padded dividers 23 may be used to divide the space. These dividers are held in place via a velcro-backed nylon tab 24 which binds to a strip of velcro 25 mounted inside the flight case. A light 26 is mounted on the side of the bag and illuminates the contents of the flight case.

The removable headset module 3 as well as a removable module 27 capable of accommodating a water bottle within its elasticized mesh pocket 28 and a handheld transceiver 29 is shown.

Turning our attention to FIG. 3, an exploded view of the present invention is drawn in perspective. The organizer 2 is shown in the open and unfolded configuration as zipper 16 is opened, the mobile member of the organizer 30 is free to rotate about its axis 31 until it reaches the fully open position at 87 degrees from the vertical. With the bag in the open state, the stretchable skirt 17 is shown in the unstretched configuration.

The organizer contains a light 32 capable of illuminating its contents as well as multiple removable enclosure pockets 33. The enclosure pockets are secured to the organizer by velcro strips located in the back of the enclosure pockets 34 and on the inside surfaces of the organizer 35, thus permitting the user to customize the organizer's layout. Each enclosure pocket contains multiple layers of pockets 36, 37 arranged in a stair-like fashion and sized to accommodate common items used in aviation.

This figure also illustrates the tab 38 and slot 39 mechanism used to secure the removable modules containing the headset 3 and the beverage holder/transceiver 27 mounted to the rigid flight case 1. A bolt 40, passing through the flight case and the tab at 41 and 42 respectively secures this assembly.

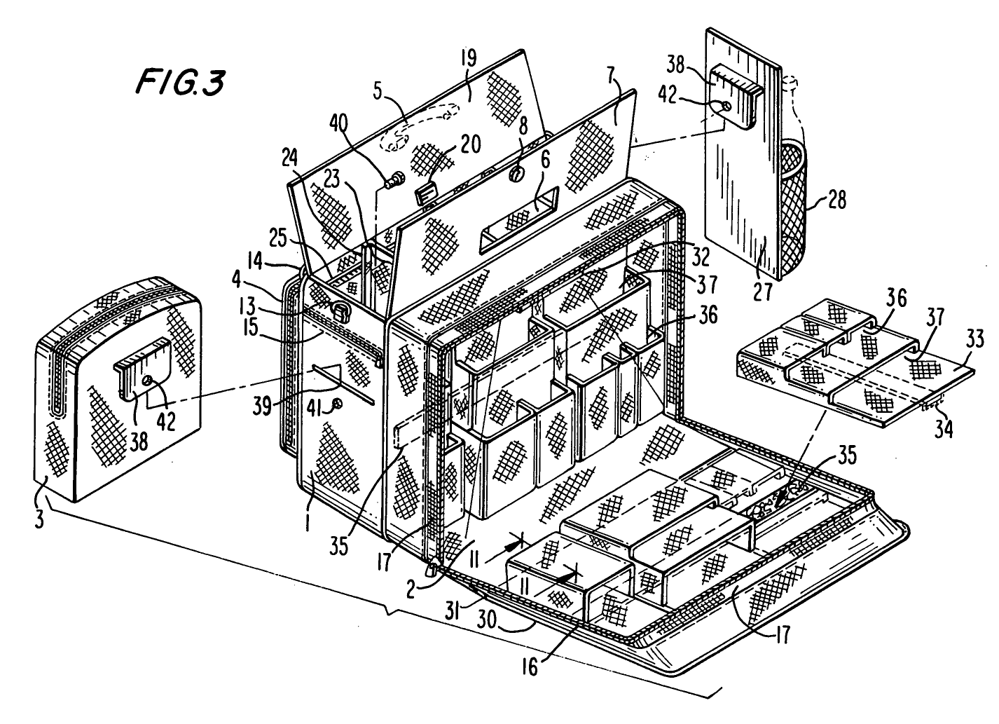

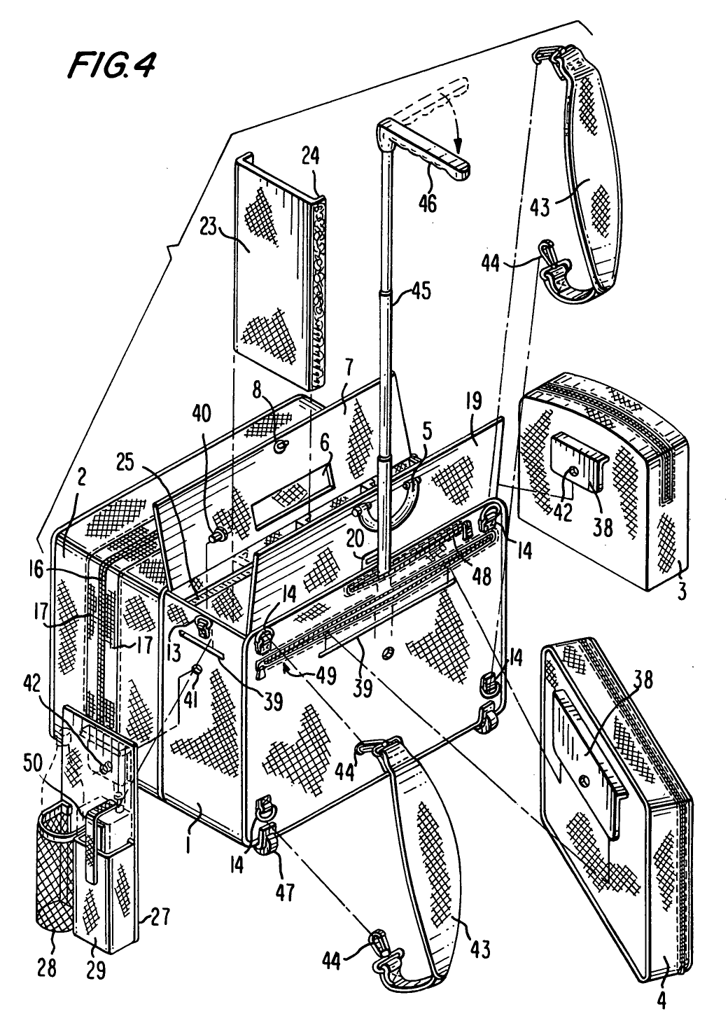

Referring now FIG. 4. The module containing the laptop 4 is also secured to the rigid flight case through the use of a tab 38 and slot 39 mechanism in the fashion described previously. Wide shoulder straps 43 which are comprised of clips 44 attach to the rigid flight case by means of D-rings 14 and can be used to carry the bag as a backpack. Alternatively, a telescoping arm 45 and handle 46 can be used to roll the bag on its integrated wheels 47. The telescopic arm and handle can be stored within a zippered compartment 48, in the bag's rear side, when not in use. A separate large zippered compartment in the back of the flight bag 49 is illustrated. FIG. 4 also demonstrates the slotted flap 50, permitting the transceiver placed in pocket 29 to be securely held while allowing its antenna to protrude upwards.

FIG. 5 illustrates a side view, showing the organizer in the open configuration and with the laptop module 4 attached. A plastic foot 51, mounted on the stationary member of the organizer 52 is shown and serves to keep the bag upright when vertical. D-rings attached to the underside of the bag 53 are used, in conjunction with a removable elasticized belt, to secure the bag to the horizontal portion of the aircraft seat when the bag is used in flight. The integrated lighting element 32 described previously, distributes a tight beam of red light within the organizer.

FIG. 6 portrays the hinge-type mechanism linking the organizer to the rigid flight case. It is comprised of a stationary member 52 which is a continuation of the bottom of the rigid flight case, and the mobile member of the organizer, 30. Both members contain complementary integrated piano-like hinges 54 which allow for rotation about the horizontal axis 31. A pin 55 is inserted through the hinges to fasten the two members together. The neck of the hinges 56 located on the mobile member are shaped so as to limit the mobile member from over-extending.

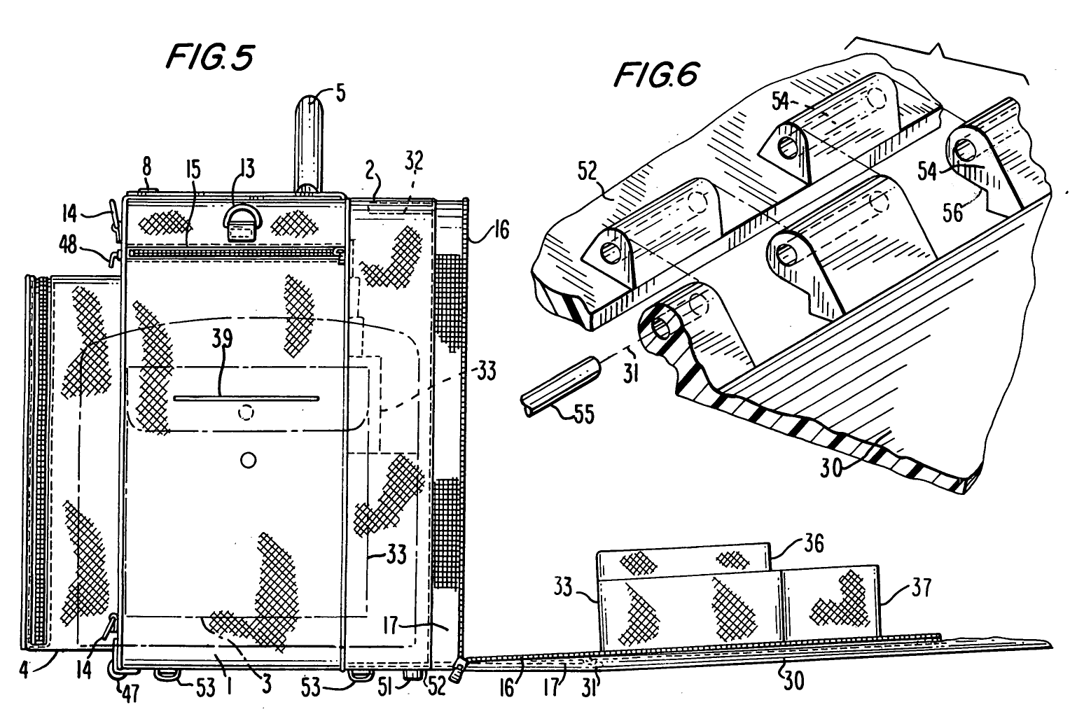

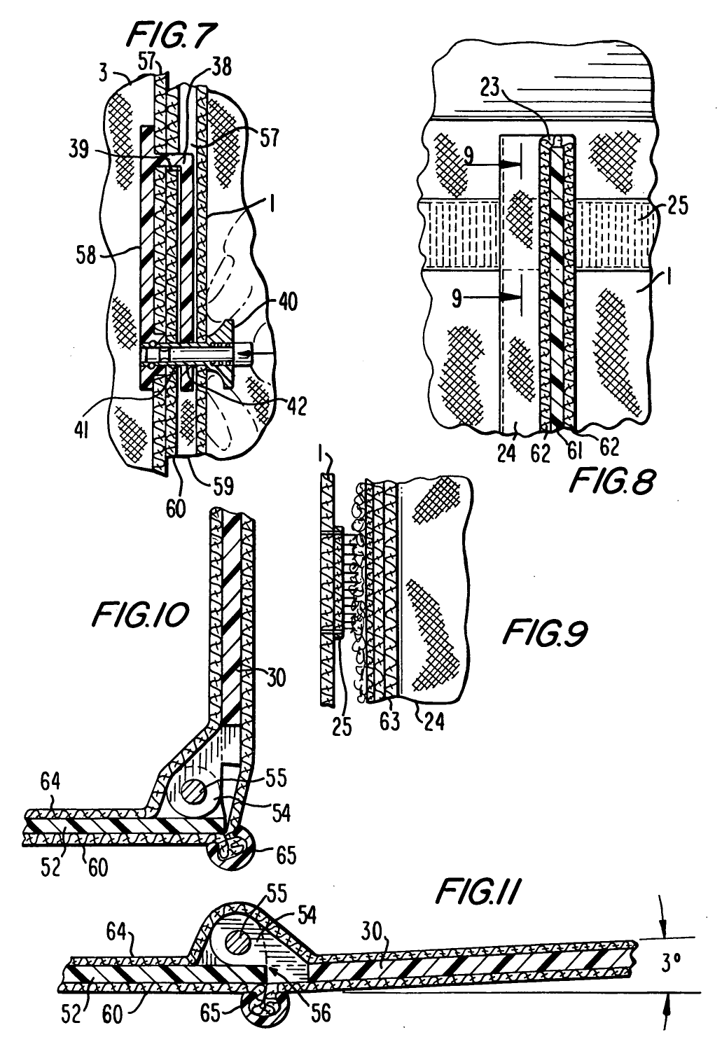

FIG. 7 illustrates the tab and slot mechanism in cross-sectional detail. The left portion of the figure illustrates the detachable headset module 3, which is comprised of a padded fabric back wall 57 and a protruding tab 38. This protruding tab is the outwardly visible portion of a semi-rigid material 58 which lines the headset bag, gives it its general shape and protects its contents.

This tab 38 is inserted into slot 39 and fills the potential space 59 located between the rigid flight case 1 and the material which wraps the case on the outside and serves as the bag's outermost lining (skin) 60. A bolt 40, passing through the flight case and the tab at 41 and 42 respectively secures this assembly.

FIG. 8 and FIG. 9 illustrate the padded dividers 23, located inside the flight case, in cross-sectional detail. Each divider is comprised of a semi-rigid foam like material 61 and lined on both sides with a thick nylon material 62. A tab consisting of nylon lining 24 protrudes from the divider. As shown in FIG. 9, this tab is lined with velcro 63 and binds to the strip of velcro, 25, which is affixed inside the flight case 1.

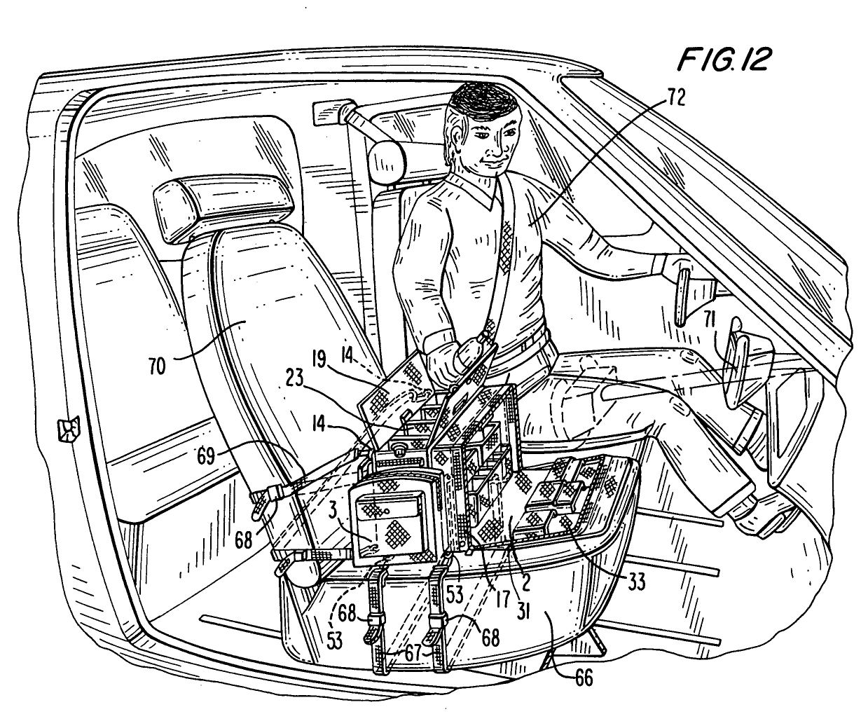

FIG. 10 and FIG. 11 illustrate a detailed cross-sectional view of the hinge-type mechanism of the organizer's mobile member in the closed, FIG. 10, and opened, FIG. 11, positions. Both the fixed and mobile members are lined interiorly 64 and exteriorly 60 with material capable of stretching. A trim 65 is sewn to help prevent the material lining the outside of the bag from sagging while the organizer is in the closed configuration. While free rotation about the pin 55 is possible, the piano hinge 54 is shaped 56 so as to limit the maximal opening of the mobile member to 87 degrees relative to the vertical.

Having described the preferred embodiment in detail, we now turn to FIG. 12 which illustrates the preferred application of the organizer tote bag for use in an airplane. The pilot bag is secured to the aircraft seat 66 by means of two elasticized straps 67 the length of which may be adjusted by means of a buckle 68. These straps, which run parallel to each other and course under the seat, are attached to the pilot bag by means of clips and D-rings located underneath the bag 53. In a similar fashion, two adjustable length elasticized straps 69 crisscross behind the seatback 70 and are attached to the bag by means of clips and D-rings 14, mounted on the backside of the pilot bag. This system which quickly and securely fastens the pilot bag to the aircraft insures that the bag remains free from interfering with the travel of the flight controls 71.

FIG. 12 also illustrates the spatial relationships between the aircraft, the pilot and the pilot bag. The organizer 2, shown in the open configuration, never interferes with the flight controls 71 as it remains safely below its path of travel. The pilot 72, seated in the adjacent seat, has convenient and complete access to aviation related materials stored within the enclosure pockets 33. This view also illustrates that the flight bag does not take up so much space that it would interfere with a pilot's movements or restrict outside visibility.

1) A convertible tote-style pilot bag and in-flight cockpit organizer for use with an airplane seat, said organizer comprising:
a flight case of substantially rectangular shape constructed of a rigid material and measuring approximately 15 inches in length, 12 inches in height and 6 inches in thickness;
an organizer constructed of a rigid backbone and capable of storing aviation related items for transport in a closed and carrying position and allowing the pilot to conveniently access any item therein contained without hindrance of any retaining straps and further having a mobile member;
a hinge-type mechanism, integrated within the mobile member of the organizer and attached to said flight case, limiting the mobile member from over-extending;
a plurality of removable enclosure defining pockets, as well as secondary layers of pockets incorporated into both sides of the organizer;
removable storage modules designed to hold an aviation headset, a laptop computer and an emergency transceiver and a beverage and capable of being fastened to the said flight case through a slot and tab mechanism and secured through a bolt;
an integrated lighting system permitting visualization of the aviation related items while at night;
a strap system allowing the pilot bag to be carried over a shoulder as a tote bag or over both shoulders as a backpack while in the closed and carrying position and securing the pilot bag to an aircraft seat while in the unfolded condition;
an integrated set of wheels and retractable handle allowing the pilot bag to be rolled.

2) The convertible tote-style pilot bag and in-flight cockpit organizer as defined in claim 1, further comprising adjustable padded dividers held in place with velcro tabs within the flight case.

3) The convertible tote-style pilot bag and in-flight cockpit organizer as defined in claim 1, further comprising an adjustable strap system capable of securing the bag to the aircraft seat when in the open position while allowing the bag to be carried either on the shoulder as a tote bag or on both shoulders as a backpack.

4) The convertible tote-style pilot bag and in-flight cockpit organizer as defined in claim 1, further comprising an organizer which is hinged from the bottom and opens in such fashion as to use the horizontal part of the aircraft seat for storing flight related items.

5) The convertible tote-style pilot bag and in-flight cockpit organizer as defined in claim 1, further comprising a hinge type mechanism preventing the mobile member of the organizer from rotating past a predetermined position, not exceeding about 87 degrees.

6) The convertible tote-style pilot bag and in-flight cockpit organizer as defined in claim 1, further comprising a zipper closure around a skirt made of stretchable material allowing the mobile member of the organizer to be securely fastened to the flight case without overstressing the zipper when the organizer is overloaded with bulky items.

7) The convertible tote-style pilot bag and in-flight cockpit organizer as defined in claim 1, further comprising an organizer with a plurality of enclosure defining pockets, as well as secondary layers of pockets incorporated into both sides of the organizer.

8) The convertible tote-style pilot bag and in-flight cockpit organizer as defined in claim 1, wherein said enclosure defining pockets are removable permitting a user-customized layout.

9) The convertible tote-style pilot bag and in-flight cockpit organizer as defined in claim 1, wherein said enclosure defining pockets further comprises at least one mesh screen pocket.

10) The convertible tote-style pilot bag and in-flight cockpit organizer as defined in claim 1, wherein at least one enclosure defining pocket further comprises a covering flap.

11) The convertible tote-style pilot bag and in-flight cockpit organizer as defined in claim 1, wherein at least one enclosure defining pocket further comprises an elasticized opening capable of retaining items placed within.

12) The convertible tote-style pilot bag and in-flight cockpit organizer as defined in claim 1, wherein at least one enclosure defining pocket further comprises a zipper closure.

13) The convertible tote-style pilot bag and in-flight cockpit organizer as defined in claim 1, wherein at least one module may be fastened through the use of a slot and tab mechanism secured via a bolt mechanism.

14) The convertible tote-style pilot bag and in-flight cockpit organizer as defined in claim 1, wherein at least one fiber optic light is integrated into a compartment of the pilot bag.

15) A convertible tote-style pilot bag for use with an aircraft, said bag comprising in combination:
a rigid wall flight case;
adjustable padded dividers within the flight case;
a lockable compartment;
an integrated convertible flight organizer, comprised of a mobile member which is hinged at the bottom, capable of storing and transporting items when closed and organizing and presenting aviation related items while inflight;
a mechanism which prevents the mobile member of the organizer from opening at an angle greater than about 87 degrees;
a plurality of enclosure defining pockets, as well as secondary layers of pockets incorporated into both sides of the organizer;
enclosure defining pockets which can be removed and reattached permitting a customizable layout;
a zipper closure for the organizer mounted on a stretchable fabric fastened to the flight case;
an integrated lighting system allowing the aviation related items to be seen at night;
a strap system which can be used to transport the bag on a user's shoulder or back while allowing the bag to be securely fastened to the aircraft while inflight;
a wheel system and a retractable handle which can be used to roll the bag;
a slot and tab system, secured by a bolt, permitting the removal of attachments such as a headset case, a laptop computer case and a water-bottle and emergency transceiver.

16) The bag of claim 13 manufactured to a size such that it may fit on an aircraft seat without interfering with flight controls, outside visibility or pilot's freedom of movement.

17) The bag of claim 13 manufactured out of fire resistant nylon, high denier nylon, cloth or leather.

18) The bag of claim 13 extensively padded under all outside surfaces with a layer of foam under the nylon, cloth or leather skin.
